(19) United States
(12) Patent Application Publication
(10) Pub. No.: US 2005/0282708 A1
(43) Pub. Date: Dec. 22, 2005

(54) Novel esters as useful herbicidal compounds

(76) Inventor: Joel Marcel Coret, Princeton, NJ (US)

Correspondence Address: John A. Shedden, 272 Harbor Ridge Drive, Statesville, NC, 28677, US

(21) Appl. No.: 11/156,856

(22) Filed: Jun. 20, 2005

Related U.S. Application Data
(60) Provisional application No. 60/581,640, filed on Jun. 21, 2004.
(60) Provisional application No. 60/581,657, filed on Jun. 21, 2004.
(60) Provisional application No. 60/581,489, filed on Jun. 21, 2004.
(60) Provisional application No. 60/581,658, filed on Jun. 21, 2004.

(51) Int. Cl. A01N 43/40; A01N 43/50; A01N 37/34; A01N 37/00

(52) U.S. Cl. 504/255; 504/258; 504/277; 504/309; 504/313

(57) ABSTRACT

The instant invention relates to the discovery of certain novel herbicidal esters of agriculturally active acids. These esters present agronomical advantages over traditional herbicidal products by presenting multiple herbicidal mechanisms that ensure activity over a broad weed spectrum while limiting the appearance of plant resistance.

The present invention claims the benefits accorded under 35 U.S.C. 119(e) of prior provisional application Nos. 60/581,640; 60/581,657; 60/581,489; and 60/581,658: all filed 21 Jun. 2004.

### FIELD OF THE INVENTION

The instant invention relates to novel herbicidal ester compounds and the discovery that compositions containing these compounds can present many agronomical advantages over the use of traditional products.

### BACKGROUND OF THE INVENTION

Pesticides are widely regarded as an efficient way of optimizing agricultural production by reducing the pressure from pests and other organisms on the growing crops. Both the quantity and the quality of crops are increased by use of chemical compounds that reduce damage to the crop by insects, fungi or weeds.

In order to reduce the pressure of competitive vegetation on the crop, herbicides have proven effective in limiting growth of unwanted plants. The herbicidal compounds can either kill all or most vegetation that they come into contact with (total or unselective herbicides) or can selectively affect certain types of plants while barely affecting others. This is particularly helpful when a crop is unharmed by a compound whereas a broad spectrum of unwanted weeds are killed by the same compound—the compound is then said to be selective with respect to the crop and can be applied to the agricultural area even after the crop has started to grow, i.e., post-emergent. This is helpful when a herbicidal treatment is required during the growing season to control high weed pressure. Very often, weeds that spontaneously appear represent a large number of different species that react differently to herbicides. To ensure optimal control, it is common practice to apply more than one herbicidal compound in the course of a season over agricultural areas. This also reduces the probability of plants developing a resistance to any given herbicide, since different herbicides usually affect different cellular targets in the plant and so a resistant plant would need to simultaneously develop more than one mechanism or mutation (one for each herbicide applied) in order to survive and reproduce. However, this multiple application increases the cost of control for the farmer, both in costs of products, and also in labor and application times when products are applied consecutively.

Herbicidal agrochemicals are mostly applied in an aqueous solution that is sprayed over the crops or area to be treated. In order for the end-user to purchase and transport a concentrated product that can be diluted extemporaneously prior to application, the agrochemical needs to be readily dispersible in water. The successful application of an agrochemical therefore depends upon the ease with which it can be dispersed into a large volume of water, and can be affected by the length of time during which it will remain homogeneously distributed in the solution. A rapid sedimentation or separation of the active from the aqueous phase will be detrimental to the accurate distribution of the active over the treated area. Actives that are water-soluble therefore present a definite advantage in this respect. As most pesticides are water insoluble, additives need to be added to the active ingredient in order to enable it to be rapidly dispersed into the spray solution. These additives may include surfactants, emulsifiers, and solvents which will disperse and stabilize the dispersed active sufficiently for the solution to be applied as those familiar with the art of formulation will know. A drawback to this situation is the distribution of the solvents, emulsifiers, dispersants and other formulation agents over the crops despite their lack of desirable agronomical effects.

Herbicidal properties of some acid compounds as well as their salts or light alkyl esters have previously been described. In general, the saline form often presents a higher water solubility than the acid but presents the drawback of a slower penetration through the waxy cuticles covering the aerial parts of plants than the corresponding acid or esters. This can lead to a lower biological efficacy of the salt and is a reason for which the acid is usually transformed to an ester by reacting it with an alcohol group. The alcohols used are usually light mono-alcohols, e.g., methyl to octyl which often yield a water-insoluble compound that readily diffuses into plants, but needs to be formulated as previously described, leading to the distribution of additional chemicals, including solvents, over the crops. Esters of light alkyls can also present a relatively high vapor pressure which means that these compounds are relatively volatile. This volatility is a generally undesirable trait in that it leads to a loss of the active from the treated surface which not only reduces the efficacy of the compound on the target organism, it can also lead to unwanted damage and toxicity to non-target organisms that may be affected by the vapors.

It has been found, and is an object of this invention, that certain esters of agriculturally active acids present agronomical advantages over the use of traditional products. The compounds claimed in this invention can present multiple herbicidal mechanisms that ensure activity over the broadest weed spectrums while limiting appearance of resistant plants. When prepared with appropriate polyols with sufficiently hydrophilic properties, the novel esters present the capacity to be readily dispersible or to spontaneously emulsify in water upon dilution.

### SUMMARY OF THE INVENTION

The present invention relates to the discovery of certain novel herbicidal ester compounds that are generally composed of one or more herbicidal acid groups esterified onto a range of hydrophilic diols or polyols. Agricultural compositions containing these compounds realize enhanced broad spectrum herbicidal activity.

### DETAILED DESCRIPTION OF THE INVENTION

The present invention thus relates to novel herbicidal ester compounds. These compounds are composed of one or more herbicidal acid groups esterified onto a range of hydrophilic diols or polyols.

Appropriate alcohol compounds useful in the scope of this invention include: glycols (for example: ethylene glycol, propylene glycol, butylene glycol, hexylene glycol, dipropyleneglycol, triethyleneglycol, methoxytriglycol, ethoxytriglycol, and tripropyleneglycol methyl ether); sorbitol; sorbitan/sorbitol poly(oxyalkylene) condensates (in molecular weight range of 40 a.u. to 20000 a.u.); D-mannitol; D-mannitol poly(oxyalkylene) condensates (in molecular weight range of 40 a.u. to 20000 a.u.); poly(oxyalkylene)glycols in molecular weight range of 80 a.u. to 20000 a.u.; mono-capped poly(oxyalkylene)glycols in molecular weight range of 80 a.u. to 20000 a.u. capped with an alkyl or aryl group such as a C₁-C₂₂ alkyl group or a triarylphenol aryl group; pentaerythritol; pentaerythritol poly(oxyalkylene) condensates; polyvinylalcohols; glucosides; polyglucosides; polyvinylalcohol polymers; glycerol; glycerol poly(oxyalkylene) condensates; polysaccharides; polysaccharide poly(oxyalkylene) condensates; polyglycerides; polyglyceride poly(oxyalkylene) condensates; and primary and secondary amine alkoxylate condensates.

Polyoxyalkylene condensates are prepared by reacting an alkylene oxide, usually ethylene oxide or propylene oxide to a molecule presenting a sufficiently reactive proton such as a hydroxyl group, a primary or secondary amine, or water. The alkylene oxide then reacts in a chain addition reaction forming alkylene ether groups. These are hydrophilic in nature and can form a water-soluble organic polymer with terminal hydroxyl groups. Alkylene oxides are currently reacted onto many different types of molecules, e.g., alcohols (methanol, and ethanol through dodecanol), polyhydroxyls (sorbitol, sorbitan, and pentarythritol), primary and secondary amines, glycerol, glucosides, polyglycerides, ethanolamines, and etheramines. The terminal hydroxyl group can then be reacted to an acid group by an ester bond thereby creating an ester with enhanced water solubility.

Herbicidal esters on a polyalkoxylate condensates present improved foam characteristics when the condensates present an alkyl ether cap (methyl or greater), or when all reactive hydroxyl groups are esterified with acids. For compounds of this structure, there is reduced foaming and thus less foam-reducing agents are required for foam control.

Examples of novel compounds that present these characteristics and which are considered to be within the scope of the present invention are of the following formula:
(R—COO)ₙ—R′
wherein
R—COO is an acetate of an acid selected from the group consisting of:
arylalanines such as
N-benzoyl-N-(3,4-dichlorophenyl)-DL-alanine (benzoylprop), and
N-benzoyl-N-(3-chloro-4-fluorophenyl)-D-alanine (flamprop);
aryloxyphenoxypropionic acids such as
(RS)-2-[4-(3,5-dichloro-2-pyridyloxy)phenoxy]propionic acid (chlorazifop),
(R)-2-[4-(5-chloro-3-fluoro-2-pyridyloxy)phenoxy]propionic acid (clodinafop),
(RS)-2-[4-(4-chlorophenoxy)phenoxy]propionic acid (clofop),
(R)-2-[4-(4-cyano-2-fluorophenoxy)phenoxy]propionic acid (cyhalofop),
(RS)-2-[4-(2,4-dichlorophenoxy)phenoxy]propionic acid (diclofop),
(RS)-2-[4-(6-chloro-1,3-benzoxazol-2-yloxy)phenoxy]propionic acid (fenoxaprop),
(R)-2-[4-(6-chloro-1,3-benzoxazol-2-yloxy)phenoxy]propionic acid (fenoxaprop-P),
(RS)-2-[4-(5-trifluoromethyl-2-pyridyloxy)phenoxy]propionic acid (fluazifop),
(R)-2-[4-(5-trifluoromethyl-2-pyridyloxy)phenoxy]propionic acid (fluazifop-P),
(RS)-2-[4-(3-chloro-5-trifluoromethyl-2-pyridyloxy)phenoxy]propionic acid (haloxyfop),
(RS)-2-{4-[3-chloro-5-(trifluoromethyl)-2-pyridyloxy]phenoxy}propionic acid (haloxyfop),
(RS)-2-[4-(6-chloroquinoxalin-2-yloxy)phenoxy]propionic acid (quizalofop),
(R)-2-[4-(6-chloroquinoxalin-2-yloxy)phenoxy]propionic acid (quizalofop-P), and
(RS)-2-[4-(α,α,α-trifluoro-p-tolyloxy)phenoxy]propionic acid (trifop);
benzoic acids such as
3-amino-2,5-dichlorobenzoic acid (chloramben),
3,6-dichloroanisic acid (dicamba), and
3,5,6-trichloro-o-anisic acid (tricamba);
cyclohexene oximes such as
(E)-(RS)-3-[1-(allyloxyimino)butyl]4-hydroxy-6,6-dimethyl-2-oxocyclohex-3-enecarboxylic acid (alloxydim);
dicarboximides such as
(RS)-2-(5-ethyl-2-{4-[1,2,3,6-tetrahydro-3-methyl-2,6-dioxo-4-(trifluoromethyl)pyrimidin-1-yl]phenoxymethyl}phenoxy)propionic acid (benzfendizone),
(Z)-2-chloro-3-[2-chloro-5-(cyclohex-1-ene-1,2-dicarboximido)phenyl]acrylic acid (cinidon), and
[2-chloro-5-(cyclohex-1-ene-1,2-dicarboximido)-4-fluororophenoxy]acetic acid (flumiclorac);
imidazolinones such as
2-[4,5-dihydro-4-methyl-4-(1-methylethyl)-5-oxo-1H-imidazol-2-yl]-4(or 5)-methylbenzoic acid (imazamethabenz),
(RS)-2-(4-isopropyl-4-methyl-5-oxo-2-imidazolin-2-yl)-5-methoxymethylnicotinic acid (imazamox),
(RS)-2-(4-isopropyl-4-methyl-5-oxo-2-imidazolin-2-yl)-5-methylnicotinic acid (imazapic),
2-(4-isopropyl-4-methyl-5-oxo-2-imidazolin-2-yl)nicotinic acid (imazapyr)
(RS)-2-(4-isopropyl-4-methyl-5-oxo-2-imidazolin-2-yl)quinoline-3-carboxylic acid (imazaquin), and
(RS)-5-ethyl-2-(4-isopropylmethyl-5-oxo-2-imidazolin-2-yl)nicotinic acid (imazethapyr);
nitrophenyl ethers such as
5-(2-chloro-α,α,α-trifluoro-p-tolyloxy)-2-nitrobenzoic acid (acifluorfen),
5-(2,4-dichlorophenoxy)-2-nitrobenzoic acid (bifenox),
O-[5-(2-chloro-α,α,α-trifluoro-p-tolyloxy)-2-nitrobenzoyl]glycolic acid (fluoroglycofen), and
O-[5-(2-chloro-α,α,α-trifluoro-p-tolyloxy)-2-nitrobenzoyl]-DL-lactic acid (lactofen);
phenoxyacetic acids such as
(2,4-dichlorophenoxy)acetic acid (2,4-D),
4-chlorophenoxyacetic acid (4-CPA), and
(4-chloro-2-methylphenoxy)acetic acid (mcpa);
phenoxybutyric acids such as
4-(2,4-dichlorophenoxy)butyric acid (2,4-DB), and
4-(4-chloro-o-tolyloxy)butyric acid (mcpb);
phenoxypropionic acids such as
(RS)-2-(3-chlorophenoxy)propionic acid (cloprop),
(RS)-2-(2,4-dichlorophenoxy)propionic acid (dichlorprop),
(R)-2-(2,4-dichlorophenoxy)propionic acid (dichlorprop-P),
(RS)-2-(4-chlorotolyloxy)propionic acid (mecoprop), and
(R)-2-(4-chloro-o-tolyloxy)propionic acid (mecoprop-P);
picolinic acids such as
4-amino-3,6-dichloropyridine-2-carboxylic acid (aminopyralid),
3,6-dichloropyridine-2-carboxylic acid (clopyralid),
4-amino-3,5-dichloro-6-fluoro-2-pyridyloxyacetic acid (fluroxypyr), and
4-amino-3,5,6-trichloropyridine-2-carboxylic acid (picloram);
pyrazolphenyls such as
5-[4-bromo-1-methyl-5-(trifluoromethyl)pyrazol-3-yl]-2-chloro-4-fluorobenzoic acid (fluazolate), and
2-chloro-5-(4-chloro-5-difluoromethoxy-1-methylpyrazol-3-yl)-4-fluorophenoxyacetic acid (pyraflufen);
pyridazinones such as
2-chloro-5-[1,6-dihydro-5-methyl-6-oxo-4-(trifluoromethyl)pyridazin-1-yl]4 fluorophenoxyacetic acid (flufenpyr),
5-bromo-1,6-dihydro-6-oxo-1-phenylpyridazin-4-yloxamic acid (oxapyrazon), and
(RS)-hexahydro-4-hydroxy-3,6-dioxopyridazin-4-ylacetic acid (pydanon);
pyridines such as
2-difluoromethyl-5-(4,5-dihydro-1,3-thiazol-2-yl)₄-isobutyl-6-trifluoromethylnicotinic acid (thiazopyr), and
3,5,6-trichloro-2-pyridyloxyacetic acid (Triclopyr);
pyrimidinyloxybenzoics such as
2,6-bis(4,6-dimethoxypyrimidin-2-yloxy)benzoic acid (Bispyribac), and
2-(4,6-dimethoxypyrimidin-2-yloxy)-6-(1-methoxyiminoethyl)benzoic acid (Pyriminobac);
pyrimidinylthiobenzoic acids such as
2-chloro-6-(4,6-dimethoxypyrimidin-2-ylthio)benzoic acid (pyrithiobac);
quinolinecarboxylics such as
3,7-dichloroquinoline-8-carboxylic acid (Quinclorac), and
7-chloro-3-methylquinoline-8-carboxylic acid (Quinmerac);
sulfonanilides such as
3-chloro-2-(5-ethoxy-7-fluoro[1,2,4]triazolo[1,5-c]pyrimidin-2-ylsulfonamido)benzoic acid (Cloransulam), and
triazolones such as
(RS)-2-chloro-3-{2-chloro-5-[4-(difluoromethyl)-4,5-dihydro-3-methyl-5-oxo-1H-1,2,4-triazol-1-yl]4-fluorophenyl}propionic acid (Carfentrazone);
unclassified such as
[2-chloro-4-fluoro-5-(5,6,7,8-tetrahydro-3-oxo-1H,3H-[1,3,4]thiadiazolo[3,4-a]pyridazin-1-ylideneamino)phenylthio]acetic acid (Fluthiacet);
uracils such as
1-(allyloxycarbonyl)-1-methylethyl 2-chloro-5-[1,2,3,6-tetrahydro-3-methyl-2,6-dioxo-4-(trifluoromethyl)pyrimidin-1-yl]benzoic acid (Butafenacil), and
2-chloro-5-(1,2,3,6-tetrahydro-3-methyl-2,6-dioxo-4-trifluoromethylpyrimidin-1-yl)benzoic acid (flupropasil);
Phosphonic acid derivatives such as
N-(phosphonomethyl)glycine (glyphosate) and the salts thereof;
Phosphinic acid derivatives such as
4-[hydroxyl(methyl)phosphinoyl]-DL-homoalanine (glufosinate) and the salts thereof;
Sulfonylurea derivatives such as
3-chloro-5-(4,6-dimethoxypyrimidin-2-ylcarbamoylsulfamoyl)-1-methylpyrazole-4-carboxylic acid (Halosulfuron) EP-A0282613,
3-[(4,6-dimethoxypyrimidin-2-ylcarbamoyl)sulfamoyl]-6-(trifluoromethyl)nicotinic acid (Flupyrsulfuron) see Brighton Crop Prot. Conf. Weeds, 1995, p. 49);
2-[[[[(4,6-dimethoxy-2-pyrimidinyl)amino]carbonyl]amino]sulfonyl]4 [[(methylsulfonyl)amino]methyl]benzoic acid (Mesosulfuron),
2-[4,6-bis(difluoromethoxy)pyrimidin-2-ylcarbamoylsulfamoyl]benzoic acid (Primisulfuron),
5-[(4,6-dimethoxypyrimidin-2-ylcarbamoyl)sulfamoyl]-1-methylpyrazole-4-carboxylic acid (Pyrazosulfuron),
3-chloro-5-(4,6-dimethoxypyrimidin-2-ylcarbamoylsulfamoyl)-1-methylpyrazole-4-carboxylic acid (EP-A 0 282 613),
5-(4,6-dimethylpyrimidin-2-yl-carbamoylsulfamoyl)-1-(2-pyridyl)pyrazole-4-carboxylic acid (NC-330, see Brighton Crop Prot. Conference ‘Weeds’ 1991, Vol. 1, p 45 et seq.),
3-chloro-2-(5-ethoxy-7-fluoro[1,2,4]triazolo[1,5-c]pyrimidin-2-ylsulfonamido)benzoic acid (Cloransulam),
2-[(4-ethoxy-6-methylamino-1,3,5-triazin-2-yl)carbamoylsulfamoyl]benzoic acid (Ethametsulfuron),
4-iodo-2-[3-(4-methoxy-6-methyl-1,3,5-triazin-2-yl)ureidosulfonyl]benzoic acid (Iodosulfuron) WO92/13845,
3-(4-methoxy-6-methyl-1,3,5-triazin-2-ylcarbamoylsulfamoyl)thiophene-2-carboxylic acid (Thifensulfuron),
2-[4-methoxy-6-methyl-1,3,5-triazin-2-yl(methyl)carbamoylsulfamoyl]benzoic acid (Tribenuron),
2-[4-dimethylamino-6-(2,2,2-trifluoroethoxy)-1,3,5-triazin-2-ylcarbamoylsulfamoyl]-m-toluic acid (Triflusulfuron), and
3-(4-ethyl-6-methoxy-1,3,5-triazin-2-yl)-1-(2,3-dihydro-1,1-dioxo-2-methylbenzo[b]thiophen-7-sulfonyl)urea (EP-A 0 796 83);
urea derivatives such as
2-{1-[4-(3,5-difluorophenyl)semicarbazono]ethyl}nicotinic acid (diflufenzopyr);
R′ is an alkyl group of a polyol containing two or more carbon atoms, which may be linear or branched, saturated or unsaturated, substituted or unsubstituted, optionally having heteroatoms such as N or O within the group. R′ is preferably the alkyl group of a polyol selected from the group consisting of:
   glycols (for example: ethylene glycol, propylene glycol, butylene glycol, hexylene glycol, dipropyleneglycol, triethyleneglycol, methoxytriglycol, ethoxytriglycol, and tripropyleneglycol methyl ether),
   sorbitol,
   sorbitan/sorbitol poly(oxyalkylene) condensates (in molecular weight range of 40 a.u. to 20000 a.u.),
   D-mannitol,
   D-mannitol poly(oxyalkylene) condensates (in molecular weight range of 40 a.u. to 20000 a.u.),
   poly(oxyalkylene)glycols in molecular weight range of 80 a.u. to 20000 a.u.,
   mono-capped poly(oxyalkylene)glycols in molecular weight range of 80 a.u. to 20000 a.u. capped with an alkyl or aryl group,
   pentaerythritol,
   pentaerythritol poly(oxyalkylene) condensates,
   polyvinylalcohols,
   glucosides,
   polyglucosides,
   polyvinylalcohol polymers,
   glycerol,
   glycerol poly(oxyalkylene) condensates,
   polysaccharides; polysaccharide poly(oxyalkylene) condensates,
   polyglycerides,
   polyglyceride poly(oxyalkylene) condensates,
   poly(oxyalkylene)amines, and
   poly(oxyalkylene)etheramines; and
      n is 1 or greater; the maximum number being determined according to the polyol, i.e., the degree of esterification can be as high as the polyol will allow (determined by the number of reactive hydroxyl groups present), but is preferably chosen so that the resulting polyester is composed of at least 20% by weight of the alcohol group which will enhance the dispersibility of the compound in water. Preferably n is from 1 to 3; most preferably 1 to 2.

Among the preferred esters are those of the following formula: 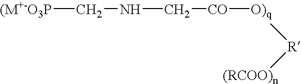
wherein M⁺ is an agronomically acceptable cation such as sodium, potassium, ammonium, alkylamines, dialkylamines, alkanolamines, and trimethylsulfonium; and R′, (RCOO), and n are as defined above and q is equal to 1 or greater.

Also among the preferred esters are those of the following formula: 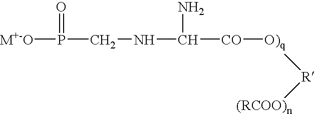
wherein M⁺ is an agronomically acceptable cation such as sodium, potassium, ammonium, alkylamines, dialkylamines, alkanolamines, and trimethylsulfonium; and R′, (RCOO), and n are also as defined above and q is 1 or greater, the maximum number being determined according to the degree of esterification that the polyol will allow.

Additionally, preferred compounds are of the formula:
(R¹—CO—O)ₙ—R³—(O—OC—R²)ₘ
wherein R¹—CO—O each independently represents an acetate of an acid selected from the group consisting of:
3-chloro-5-(4,6-dimethoxypyrimidin-2-ylcarbarnoylsulfamoyl)-1-methylpyrazole-4-carboxylic acid (Halosulfuron) EP-A0282613,
3-[(4,6-dimethoxypyrimidin-2-ylcarbamoyl)sulfamoyl]-6-(trifluoromethyl)nicotinic acid (Flupyrsulfuron) see Brighton Crop Prot. Conf. Weeds, 1995, p. 49),
2-[[[[(4,6-dimethoxy-2-pyrimidinyl)amino]carbonyl]amino]sulfonyl]4-[[(methylsulfonyl)amino]methyl]benzoic acid (Mesosulfuron),
2-[4,6-bis(difluoromethoxy)pyrimidin-2-ylcarbamoylsulfamoyl]benzoic acid (Primisulfuron),
5-[(4,6-dimethoxypyrimidin-2-ylcarbamoyl)sulfamoyl]-1-methylpyrazole-4-carboxylic acid (Pyrazosulfuron),
3-chloro-5-(4,6-dimethoxypyrimidin-2-ylcarbamoylsulfamoyl)-1-methylpyrazolecarboxylate (EP-A 0 282 613),
5-(4,6-dimethylpyrimidin-2-yl-carbamoylsulfamoyl)-1-(2-pyrid-yl)pyrazole-4-carboxylic acid (NC-330, see Brighton Crop Prot. Conference ‘Weeds’ 1991, Vol. 1, p 45 et seq.),
3-chloro-2-(5-ethoxy-7-fluoro[1,2,4]triazolo[1,5-c]pyrimidin-2-ylsulfonamido)benzoic acid (Cloransulam),
2-[(4-ethoxy-6-methylamino-1,3,5-triazin-2-yl)carbamoylsulfamoyl]benzoic acid (Ethametsulfuron),
4-iodo-2-[3-(4-methoxy-6-methyl-1,3,5-triazin-2-yl)ureidosulfonyl]benzoic acid (Iodosulfuron) WO92/13845,
3-(4-methoxy-6-methyl-1,3,5-triazin-2-ylcarbamoylsulfamoyl)thiophene-2-carboxylic acid (Thifensulfuron),
2-[4-methoxy-6-methyl-1,3,5-triazin-2-yl(methyl)carbamoylsulfamoyl]benzoic acid (Tribenuron),
2-[4-dimethylamino-6-(2,2,2-trifluoroethoxy)-1,3,5-triazin-2-ylcarbamoylsulfamoyl]-m-toluic acid (Triflusulfuron), and
3-(4-ethyl-6-methoxy-1,3,5-triazin-2-yl)-1-(2,3-dihydro-1,1-dioxo-2-methylbenzo[b]thiophen-7-sulfonyl)urea (EP-A 0 796 83);
   wherein R²—CO—O each independently represents an acetate of an acid selected from the group consisting of:
N-benzoyl-N-(3,4-dichlorophenyl)-DL-alanine (benzoylprop),
N-benzoyl-N-(3-chloro-4-fluorophenyl)-D-alanine (flamprop),
(RS)-2-[4-(3,5-dichloro-2-pyridyloxy)phenoxy]propionic acid (chlorazifop),
(R)-2-[4-(5-chloro-3-fluoro-2-pyridyloxy)phenoxy]propionic acid (clodinafop),
(RS)-2-[4-(4-chlorophenoxy)phenoxy]propionic acid (clofop),
(R)-2-[4-(4-cyano-2-fluorophenoxy)phenoxy]propionic acid (cyhalofop),
(RS)-2-[4-(2,4-dichlorophenoxy)phenoxy]propionic acid (diclofop),
(RS)-2-[4-(6-chloro-1,3-benzoxazol-2-yloxy)phenoxy]propionic acid (fenoxaprop),
(R)-2-[4-(6-chloro-1,3-benzoxazol-2-yloxy)phenoxy]propionic acid (fenoxaprop-P),
(RS)-2-[4-(5-trifluoromethyl-2-pyridyloxy)phenoxy]propionic acid (fluazifop),
(R)-2-[4-(5-trifluoromethyl-2-pyridyloxy)phenoxy]propionic acid (fluazifop-P),
(RS)-2-{4-[3-chloro-5-(trifluoromethyl)-2-pyridyloxy]phenoxy}propionic acid (haloxyfop),
(RS)-2-[4-(6-chloroquinoxalin-2-yloxy)phenoxy]propionic acid (quizalofop),
(R)-2-[4-(6-chloroquinoxalin-2-yloxy)phenoxy]propionic acid (quizalofop-P),
(RS)-2-[4-(α,α,α-trifluoro-p-tolyloxy)phenoxy]propionic acid (trifop),
3-amino-2,5-dichlorobenzoic acid (chloramben),
3,6-dichloro-o-anisic acid (dicamba),
3,5,6-trichloro-o-anisic acid (tricamba),
(E)-(RS)-3-[1-(allyloxyimino)butyl]4-hydroxy-6,6-dimethyl-2-oxocyclohex-3-enecarboxylic acid (alloxydim),
(RS)-2-(5-ethyl-2-(4-[1,2,3,6-tetrahydro-3-methyl-2,6-dioxo-4-(trifluoromethyl)pyrimidin-1-yl]phenoxymethyl)phenoxy)propionic acid (benzfendizone),
(Z)-2-chloro-3-[2-chloro-5-(cyclohex-1-ene-1,2-dicarboximido)phenyl]acrylic acid (cinidon),
[2-chloro-5-(cyclohex-1-ene-1,2-dicarboximido)-4-fluororophenoxy]acetic acid (flumiclorac),
2-[4,5-dihydro-4-methyl(1-methylethyl)-5-oxo-1H-imidazol-2-yl]4(or 5)-methylbenzoic acid (imazamethabenz),
(RS)-2-(4-isopropyl-4-methyl-5-oxo-2-imidazolin-2-yl)-5-methoxymethylnicotinic acid (imazamox),
(RS)-2-(4-isopropyl-4-methyl-5-oxo-2-imidazolin-2-yl)-5-methylnicotinic acid (imazapic),
2-(4-isopropylmethyl-5-oxo-2-imidazolin-2-yl)nicotinic acid (imazapyr),
(RS)-2-(4-isopropyl-4-methyl-5-oxo-2-imidazolin-2-yl)quinoline-3-carboxylic acid (imazaquin),
(RS)-5-ethyl-2-(4-isopropylmethyl-5-oxo-2-imidazolin-2-yl)nicotinic acid (imazethapyr),
5-(2-chloro-α,α,α-trifluoro-p-tolyloxy)-2-nitrobenzoic acid (acifluorfen),
5-(2,4-dichlorophenoxy)-2-nitrobenzoic acid (bifenox),
O-[5-(2-chloro-α,α,α-trifluoro-p-tolyloxy)-2-nitrobenzoyl]glycolic acid (fluoroglycofen),
O-[5-(2-chloro-α,α,α-trifluoro-p-tolyloxy)-2-nitrobenzoyl]-DL-lactic acid (lactofen),
2,4-dichlorophenoxy)acetic acid (2,4-D),
4-chlorophenoxyacetic acid (4-CPA),
(4-chloro-2-methylphenoxy)acetic acid (mcpa),
4-(2,4-dichlorophenoxy)butyric acid (2,4-DB),
4-(4-chlorotolyloxy)butyric acid (mcpb),
(RS)-2-(3-chlorophenoxy)propionic acid (cloprop),
(RS)-2-(2,4-dichlorophenoxy)propionic acid (dichlorprop),
(R)-2-(2,4-dichlorophenoxy)propionic acid (dichlorprop-P),
RS)-2-(4-chloro-o-tolyloxy)propionic acid (mecoprop),
(R)-2-(4-chloro-o-tolyloxy)propionic acid (mecoprop-P),
4-amino-3,6-dichloropyridine-2-carboxylic acid (aminopyralid),
3,6-dichloropyridine-2-carboxylic acid (clopyralid),
4-amino-3,5-dichloro-6-fluoro-2-pyridyloxyacetic acid (fluroxypyr),
4-amino-3,5,6-trichloropyridine-2-carboxylic acid (picloram),
5-[4-bromo-1-methyl-5-(trifluoromethyl)pyrazol-3-yl]-2-chloro-4-fluorobenzoic acid (fluazolate),
2-chloro-5-(4-chloro-5-difluoromethoxy-1-methylpyrazol-3-yl)-4-fluorophenoxyacetic acid (pyraflufen),
2-chloro-5-[1,6-dihydro-5-methyl-6-oxo-4-(trifluoromethyl)pyridazin-1-yl]-4-fluorophenoxyacetic acid (flufenpyr),
5-bromo-1,6-dihydro-6-oxo-1-phenylpyridazin-4-yloxamic acid (oxapyrazon),
(RS)-hexahydro-4-hydroxy-3,6-dioxopyridazin-4-ylacetic acid (pydanon),
2-difluoromethyl-5-(4,5-dihydro-1,3-thiazol-2-yl)-4-isobutyl-6-trifluoromethylnicotinic acid (thiazopyr),
3,5,6-trichloro-2-pyridyloxyacetic acid (Triclopyr),
2,6-bis(4,6-dimethoxypyrimidin-2-yloxy)benzoic acid (Bispyribac),
2-(4,6-dimethoxypyrimidin-2-yloxy)-6-(1-methoxyiminoethyl)benzoic acid (Pyriminobac),
2-chloro-6-(4,6-dimethoxypyrimidin-2-ylthio)benzoic acid (pyrithiobac),
3,7-dichloroquinoline-8-carboxylic acid (Quinclorac),
7-chloro-3-methylquinoline-8-carboxylic acid (Quinmerac),
(RS)-2-chloro-3-{2-chloro-5-[4-(difluoromethyl)-4,5-dihydro-3-methyl-5-oxo-1H-1,2,4-triazol-1-yl]-4-fluorophenyl}propionic acid (Carfentrazone),
[2-chloro-4-fluoro-5-(5,6,7,8-tetrahydro-3-oxo-1H,3H-[1,3,4]thiadiazolo[3,4-a]pyridazin-1-ylideneamino)phenylthio]acetic acid (Fluthiacet),
1-(allyloxycarbonyl)-1-methylethyl 2-chloro-5-[1,2,3,6-tetrahydro-3-methyl-2,6-dioxo-4-(trifluoromethyl)pyrimidin-1-yl]benzoic acid (Butafenacil),
2-chloro-5-(1,2,3,6-tetrahydro-3-methyl-2,6-dioxo-4-trifluoromethylpyrimidin-1-yl)benzoic acid (flupropasil), and
2-{1-[4-(3,5-difluorophenyl)semicarbazono]ethyl}nicotinic acid (diflufenzopyr);
R³ is an alkyl group of a polyol selected from the group consisting of:
   glycols (for example: ethylene glycol, propylene glycol, butylenes glycol, hexylene glycol, dipropyleneglycol, triethyleneglycol, methoxytriglycol, ethoxytriglycol, tripropylene glycol methyl ether),
   sorbitol,
   sorbitan/sorbitol poly(oxyalkylene) condensates (in molecular weight range of 40 a.u. to 20000 a.u.),
   D-mannitol,
   D-mannitol poly(oxyalkylene) condensates (in molecular weight range of 40 a.u. to 20000 a.u.),
   poly(oxyalkylene)glycols in molecular weight range of 80 a.u. to 20000 a.u.,
   poly(oxyethylene)poly(oxypropylene)glycol in molecular weight range of 80 a.u. to 20000 a.u.,
   pentaerythritol,
   pentaerythritol poly(oxyalkylene) condensates,
   polyvinylalcohols,
   glucosides,
   polyglucosides,
   polyvinylalcohol polymers,
   glycerol,
   glycerol poly(oxyalkylene) condensates,
   polysaccharides; polysaccharide poly(oxyalkylene) condensates,
   polyglycerides,
   polyglyceride poly(oxyalkylene) condensates,
   poly(oxyalkylene)amines, and
   poly(oxyalkylene)etheramines;
n is 1 or greater; and m is 0 or greater,
   with the proviso that when n is 1, m is 1 or greater, the maximum number for m being determined according to the degree of esterification that the polyol will allow (determined by the number of hydoxyl groups present); and when n is greater than 1, m is 0 or greater, the maximum number for n or m being determined by the formula that the sum of n+m cannot exceed the maximum number determined according to the degree of esterification that the polyol will allow.

These polyesters can be prepared by an esterification reaction which can be carried out according to classical methods. Acids, acid halides or light alkyl esters thereof (methyl esters, for example) are progressively added to the polyol in the presence of an appropriate catalyst (usually an acid such as toluene sulfonic acid) in a high temperature reactor under agitation. The reaction can be improved by a continuous extraction of by-products (water or light alcohol if a light ester is used as reactant) as is commonly practiced by those familiar to the art of organic synthesis. If necessary, the use of a polar, non-protic solvent or plasticizer can be beneficial in solubilizing the reactants or in reducing the viscosity of the reactive solution.

Although compounds that are claimed in this invention present the benefits of adequate dispersibility in water with no or minimal need of emulsifiers and/or surface active agents, the active ingredients can be formulated into any herbicidal compositions that ensure appropriate handling characteristics and dispersibility of the active in order to optimize its delivery to the locus of application.

A preferred formulation for dispersible or water soluble actives is the soluble concentrate (SL), in which the active may be solubilized in an aqueous solution, which may contain surfactants and antifoams, as well as some water-soluble solvents, coupling agents or anti-freeze agents, such as a glycol. The addition of rheological modifiers, adjuvants or surfactants and foam reducing agents may also be beneficial to improve handling.

The herbicidal compositions according to the invention conventionally comprise 0.0001 to 99% by weight, preferably 0.1 to 95% by weight, of one or more herbicidal active substances.

The herbicidal compositions according to the invention present excellent herbicidal activity. The improved control of the harmful plants by the herbicidal compositions according to the invention makes it possible to reduce the application rate and/or to increase the safety margin. These advantages are desirable both from an economical and an environmental point of view.

The herbicidal compositions according to the invention are prepared by customary formulation processes, for example, by grinding, mixing, dissolving or dispersing the individual components.

The herbicidal compositions according to the invention can be formulated in various ways, depending on the prevailing biological and/or chemical-physical parameters. The following are examples of suitable formulation possibilities: soluble concentrates (SL), wettable powders (WP), water-soluble powders (SP), water-soluble concentrates, emulsifiable concentrates (EC), emulsions (EW) such as oil-in-water and water-in-oil emulsions, sprayable solutions, suspension concentrates (SC), oil- or water-based dispersions, oil-miscible solutions, capsule suspensions (CS), dusts (DP), seed-dressing materials, granules for spreading and soil application, granules (GR) in the form of microgranules, spray granules, coated granules and adsorption granules, water-dispersible granules (WG), water-soluble granules (SG), ULV formulations, microcapsules and waxes.

These individual formulation types are known in principle and are described, for example, in: Winnacker-Kuchler, “Chemische Technologie” [Chemical Engineering], Volume 7, C. Hauser Verlag Munich, 4.sup.th Ed. 1986; Wade van Valkenburg, “Pesticide Formulations”, Marcel Dekker, N.Y., 1973; and K. Martens, “Spray Drying” Handbook, 3rd Ed. 1979, G. Goodwin ltd. London.

The formulation auxiliaries required, such as inert materials, surfactants, solvents and additives, are also known and are described, for example, in Watkins, “Handbook of Insecticide Dust Diluents and Carriers”, 2nd Ed., Darland Books, Caldwell N.J.; H. v. Olphen, “Introduction to Clay Colloid Chemistry”, 2nd Ed., J. Wiley & Sons, N.Y.; C. Marsden, “Solvents Guide”, 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflchenaktive thylenoxidaddukte”, [Surface-active ethylene oxide adducts], Wiss. Verlagsgesell., Stuttgart 1976; and Winnacker-Kuchler, “Chemische Technologie”, Volume 7, C. Hauser Verlag Munich, 4.sup.th Ed. 1986.

Based on these formulations, it is also possible to prepare combinations with other agrochemical active substances such as insecticides, acaricides, safeners, fertilizers and/or growth regulators, for example in the form of a ready-mix or a tank mix.

Wettable powders are products which are uniformly dispersible in water and which, besides the herbicide and/or surfactant, also comprise diluents or inert materials and, if appropriate, further ionic and/or nonionic surfactants (wetters, dispersants), for example polyalkoxylated arylphenols, polyalkoxylated alkylphenols, polyalkoxylated fatty alcohols, polyalkoxylated fatty amines, fatty alcohol polyglycol ether sulfates, alkanesulfonates, alkylbenzenesulfonates, sodium lignosulfonates, sodium 2,2′-dinaphthylmethane-6,6′-disulfonate, sodium dibutyinaphthalene sulfonate or sodium oleoylmethyltaurine. To prepare the wettable powders, the herbicides and/or surfactants are finely ground, for example in customary apparatuses such as hammer mills, blower mills and air-jet mills, and mixed with the formulation auxiliaries, either simultaneously or subsequently. Emulsifiable concentrates are prepared by dissolving herbicide and/or surfactants in an organic solvent, for example butanol, cyclohexanone, dimethylformamide, xylene, glycols, methyl esters of natural fatty acids or else higher-boiling aromatics or hydrocarbons or mixtures of the organic solvents with addition of one or more ionic or nonionic surfactants (emulsifiers). Examples of emulsifiers which may be used are: calcium salts of alkylarylsulfonic acid, such as calcium dodecylbenzenesulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan esters such as, for example, sorbitan fatty acid esters, or polyoxyethylene sorbitan esters such as, for example, polyoxyethylene sorbitan fatty acid esters. For the herbicidal actives that contain a hydrophilic alcohol representing at least 20% of the total molecular weight of the molecule, the dispersing qualities are found to be inherently suitable, which will reduce the need for the additional surfactants given as examples here.

Dusts are obtained by grinding herbicide and/or surfactant with finely divided solid materials, for example talc, natural clays such as kaolin, bentonite, and pyrophyllite, or diatomaceous earth.

Emulsions, for example oil-in-water emulsions (EW), can be prepared for example by means of stirrers, colloid mills and/or static mixers using aqueous organic solvents and, if appropriate, further surfactants as have already been mentioned for example above in the case of the other formulation types. The stability of esters in water may be a concern, in which case the pH of the solution needs to be maintained between 6 and 7.5 to minimize hydrolytic degradation. Additionally, reductive agents can be added to the solution, or additional alcohols or polyols can be added to the solution.

Granules can be prepared either by spraying the herbicide and/or surfactants onto adsorptive, granulated inert material or by applying active ingredient concentrates to the surface of carriers such as sand, kaolinites or granulated inert material with the aid of adhesives, for example polyvinyl alcohol, sodium polyacrylate or mineral oils. Suitable herbicide may also be granulated in the manner conventionally used for the production of fertilizer granules, if desired in a mixture with fertilizers. As a rule, water-dispersible granules are prepared by conventional processes such as spray drying, fluidized-bed granulation, disk granulation, mixing with high-speed mixers and extrusion without solid inert material. Regarding the production of disk granules, fluidized-bed granules, extruder granules and spray granules, see, for example, the methods in “Spray-Drying Handbook” 3rd Ed. 1979, G. Goodwin Ltd., London; J. E. Browning, “Agglomeration”, Chemical and Engineering 1967, page 147 et seq; and “Perry's Chemical Engineer's Handbook”, 5th Ed., McGraw-Hill, New York 1973, pp. 8-57.

For further details on the formulation of crop protection products, see, for example, G. C. Klingman, “Weed Control as a Science”, John Wiley and Sons, Inc., New York, 1961, pages 81-96 and J. D. Freyer, S. A. Evans, “Weed Control Handbook”, 5th Ed., Blackwell Scientific Publications, Oxford, 1968, pages 101-103.

In addition, the abovementioned active ingredient formulations may comprise, if appropriate, additives such as adhesives, wetters, dispersants, emulsifiers, penetrants, preservatives, antifreeze agents, solvents, fillers, carriers, colorants, antifoams, evaporation inhibitors, pH regulators or viscosity regulators which are customary in each case.

The spray mixture is preferably prepared on the basis of water and/or oil, for example a high-boiling hydrocarbon such as kerosene or paraffin. The herbicidal compositions according to the invention can be formulated as a tank mix or a ready-mix.

The active ingredient concentration in wettable powders is, for example, approximately 10 to 90% by weight, the remainder to 100% by weight being composed of customary formulation constituents. In the case of emulsifiable concentrates, the active ingredient concentration may amount to approximately 1 to 90%, preferably 5 to 80% by weight. Formulations in the form of dusts comprise 1 to 30% by weight of active ingredient, preferably in most cases 5 to 20% by weight of active ingredient, sprayable solutions contain approximately 0.05 to 80%, preferably 2 to 50% by weight of active ingredient. In the case of water-dispersible granules, the active ingredient content depends partly on whether the active compound is present in liquid or solid form and on which granulation auxiliaries, fillers and the like are being used. The active ingredient content amounts to, for example, between 1 and 95% by weight, preferably to between 10 and 80% by weight in the case of the water-dispersible granules.

Upon application, the concentration of herbicide is generally 0.0001 to 20% by weight, preferably 0.01 to 3% by weight, in the composition applied, for example the spray mixture, at an application rate of 5 to 4000 l/ha, preferably 100 to 600 I/ha.

Preferably, the herbicidal compositions according to the invention additionally comprise water and if appropriate, organic solvents and are formulated in the form of an aqueous concentrated dispersion or emulsion or as a tank mix in the form of a dilute dispersion, emulsion or solution with a degree of dilution of up to that of the ready-to-use spray mixture. A herbicidal composition prepared as a tank mix and comprising, for use, the preferred amounts of herbicide is especially preferred.

Mixtures or co-formulations with other active substances such as, for example, insecticides, acaricides, herbicides, fungicides, safeners, fertilizers and/or growth regulators are possible, if appropriate.

For use, concentrated formulations which are present in commercially available form are, if appropriate, diluted in the customary fashion, for example by means of water in the case of wettable powders, emulsifiable concentrates, dispersions and water-dispersible granules. Preparations in the form of dusts, spray granules, absorption granules, sprayable solutions and spray mixtures prepared as tank mixes are not conventionally diluted further with additional inert substances prior to use.

The application rate required of the herbicides varies with the external conditions such as temperature, humidity and the nature of the herbicide used. It can vary within wide limits, for example between 0.001 and 10 kg/ha or more of active substance, but it is preferably between 0.005 and 5 kg/ha.

The herbicidal compositions according to the invention have an outstanding herbicidal activity against monocotyledonous and dicotyledonous weeds, and, as such, will be active against many crop plants. However, by choosing suitable herbicidal acids, it is possible to produce esters that are selective to certain economically important crops. For these reasons, the present compounds are highly suitable for the selective control of undesired vegetation in stands of agriculturally useful plants.

Owing to their herbicidal and plant-growth regulatory properties, the herbicidal combinations according to the invention can also be employed for controlling harmful plants in crops of genetically modified plants which are known or yet to be developed. As a rule, the transgenic plants are distinguished by particular advantageous properties, in particular, by resistances to certain pesticides, especially certain herbicides.

In the case of application to pesticide-resistant crops, the more useful herbicidal compounds in the present invention are designed by creating esters with herbicidal acids to which the crop is naturally or genetically resistant. Preferably two or more of these herbicidal acids are esterified onto a polyol to create a molecule that delivers a mix of acids onto the field. The combined effect of the various acids at different cellular targets effectively reduces or eliminates any possible resistant weed species and/or prevents the development of such resistant strains.

The compositions according to the invention may thus preferably be employed as herbicides in crops of useful plants which are resistant to the phytotoxic effects of the herbicides or which have been rendered resistant to the phytotoxic effects of the herbicides by recombinant means.

When the herbicidal compositions according to the invention are used in transgenic crops, effects are frequently observed—in addition to the effects on harmful plants which can be observed in other crops—which are specific for the application to the transgenic crop in question, for example a modified or specifically extended weed spectrum which can be controlled.

Another object of the invention is therefore also the use of the compositions according to the invention as herbicides for controlling harmful plants, preferably in crops of plants, it also being possible for the crops of plants to take the form of crops of transgenic plants.

The herbicidal compositions according to the invention can also be employed non-selectively for controlling undesired vegetation, for example in plantation crops, on verges, squares, industrial terrain or railroad tracks.

The presence of certain surfactants, oils, solvents and other formulation auxiliaries can sometimes cause injury to the crops or to useful plants. This injury is due to the phytotoxic effects that some of these compounds can have, specifically due to membrane disruption of parenchymal and epithelial cells in the leaves. The effect is visible due to yellowing of the plant leaves. This effect is usually not fatal and the crop recovers over time, but is nonetheless an undesirable trait of formulation additives.

Due to the reduced need for emulsifiers and formulation auxiliaries with autodispersable herbicidal esters, risk of chemical injury is greatly reduced and is a particularly attractive property of these novel compounds.

Another undesirable side effect of certain emulsifiers is the toxicological effect that these can have in case of accidental contact with a human. In the case of emulsifiable concentrates, this effect is especially pronounced in ocular injury when the emulsifiers contain calcium dodecylbenzenesulfonates. Again, due to the reduced need for emulsifiers and formulation auxiliaries with autodispersable herbicidal esters, risk of contact injury is greatly reduced and is another attractive property of these novel compounds.

In a preferred method variant, the herbicides are applied in application rates of from 0.1 to 2000 g of active substances/ha, preferably of from 0.5 to 1000 g of active substances/ha. It is furthermore especially preferred to apply the active ingredients in the form of a ready-mix or in the form of a tank mix, where the individual components, for example in the form of formulations, are jointly mixed with water in the tank and the resulting spray mixture is applied.

The herbicidal compositions according to the invention can be applied in the customary fashion, for example with water as carrier in spray mixture quantities of approximately 5 to 4000 liters/ha. Application of the compositions by what is known as the low-volume and ultra-low-volume methods (ULV) is also possible, as is their application in the form of granules and microgranules.

This results in a large number of possibilities of combining several active substances with each other and of employing them jointly for controlling harmful plants in crops of plants without deviating from the spirit of the invention.

The invention will now be described with reference to a number of specific examples that are to be regarded solely as illustrative of the compositions of this invention and not as restrictive of the scope thereof.

### EXAMPLE 1

249 grams of 4-(2,4-dichlorophenoxy)butyric acid and 323 grams of (E)-(RS)-3-[1-(allyloximimino)butyl]-4-hydroxy-6,6-dimethyl-2-oxocyclohex-3-enecarboxylic acid were reacted with 420 grams of polyethylene glycol 400 to form:

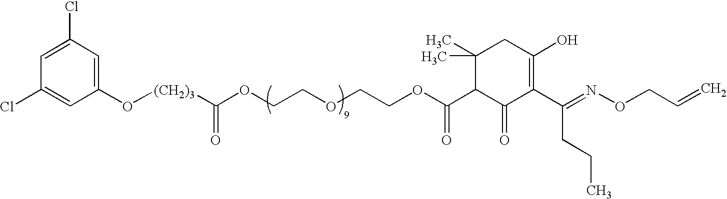

This compound is dispersible in water and presents strong herbicidal activity both on grasses and broad-leafed plant species.

### EXAMPLE 2

448 grams of 0-[5-(2-chloro-α,α,α-trifluoro-p-tolyloxy)-2-nitrobenzoyl]glycolic acid were reacted with 260 grams of butyl-polyoxyethylene glycol 200 in presence of toluenesulfonic acid at 140° C. with continuous extraction of water to form a compound that is readily dispersible in water and presents herbicidal activity on grasses and broad-leaved plant species, especially Galium and Veronia spp.

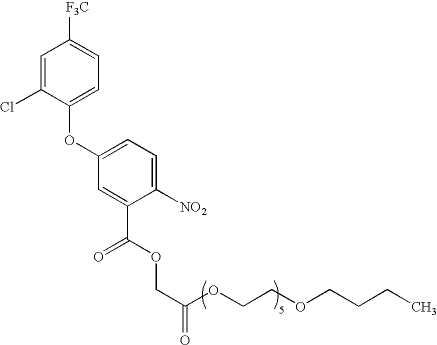

### EXAMPLE 3

325 grams of (RS)-2-[4-(5-trifluoromethyl-2-pyridyloxy)phenoxy]propionic acid were reacted with 250 grams of poly(oxyethylene)(6)poly(oxypropylene)(4)glycol to form:

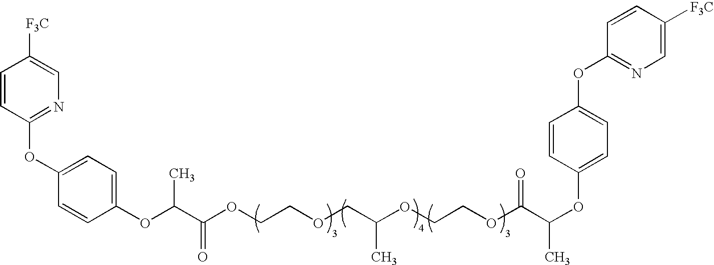

This compound is dispersible in water and presents herbicidal activity against grass species in solution at 1000 ppm concentration.

### EXAMPLE 4

325 grams of (RS)-2-[4-(5-trifluoromethyl-2-pyridyloxy)phenoxy]propionic acid and 220 grams of 3,6-dichloro-o-anisic acid were reacted with 400 grams of poly(oxyethylene)(10)glycol in presence of toluenesulfonic acid at 145° C. to form:

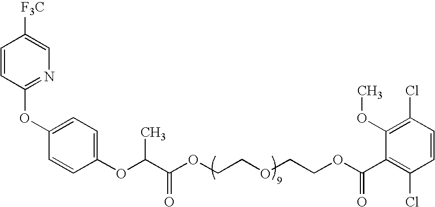

This compound is readily dispersible in water and presents strong herbicidal activity against broad-leaved plant species as well as grasses when applied to the leaves in a 1000 ppm solution.

### EXAMPLE 5

120 grams of O-[5-(2-chloro-α,α,α-trifluoro-p-tolyloxy)-2-nitrobenzoyl]glycolic acid and 140 grams of (RS)-2-(4-isopropyl-4-methyl-5-oxo-2-imidazolin-2-yl)quinoline-3-carboxylic acid were reacted with 230 grams of polyoxyethylene glycol 400 in presence of toluenesulfonic acid at 140° C. with continuous extraction of water to form a compound that is readily dispersible in water and presents herbicidal activity on grasses and broad-leaved plant species. 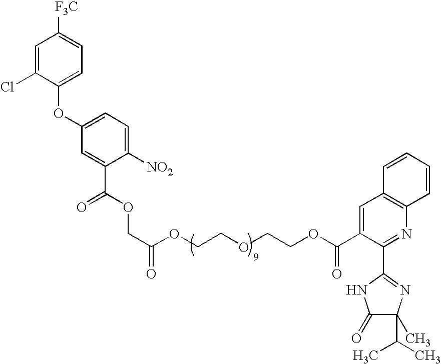
Although this invention has been described in detail with particular reference to preferred embodiments thereof, it will be understood that variations and modifications can be effected within the spirit and scope of this invention as described hereinabove and as defined in the appended claims.

In conclusion, it can be said that the herbicidal compositions according to the invention have an outstanding herbicidal action and that in a preferred embodiment selectivity to useful crops is observed. The novel compounds present extremely broad spectrum of activity against weeds, a reduced need for formulation auxiliaries, reduced injury of crops and improved toxicological profiles of the finished compositions with regards to the end-user in case of accidental contact. Furthermore, the elimination of certain formulation auxiliaries can lead to improved ecotoxicological profiles, especially with respect to aquatic fauna and flora.

The above-mentioned properties are required in weed control practice in order to keep agricultural crops free from undesired plant competitors and thus to safeguard and/or increase the yields in terms of quality and quantity. The current invention allows the user to attain a new level of broad-spectrum weed control as well as high selectivity with reduced appearance of weed resistance. Thus, a considerably improved reliability of action is observed under different environmental conditions.

1. A compound of the formula: (RCOO)ₙ—R′
wherein RCOO is each independently an acetate of an acid selected from the group consisting of
arylalanines, aryloxyphenoxypropionic acids, benzoic acids, cyclohexene oximes, dicarboximides, imidazolinones, nitrophenyl ethers, phenoxyacetic acids. phenoxybutyric acids, phenoxypropionic acids, picolinic acids, pyrazolphenyls, pyridazinones, pyridines, pyrimidinyloxybenzoics, pyrimidinylthiobenzoic acids, quinolinecarboxylics, sulfonanilides, triazolones, uracils, phosphinic acid, phosphonic acid, sulfonylurea and urea derivatives;
R′ is an alkyl group of a polyol containing two or more carbon atoms, which may be linear or branched, saturated or unsaturated, substituted or unsubstituted; and
n is 1 or greater, the maximum number being determined according to the degree of esterification that the polyol will allow.

2. A compound of the formula (RCOO)ₙ—R′
wherein RCOO is each independently an acetate of an acid selected from the group consisting of
N-benzoyl-N-(3,4-dichlorophenyl)-DL-alanine(benzoylprop),
N-benzoyl-N-(3-chloro-4-fluorophenyl)-D-alanine (flamprop-M),
(RS)-2-[4-(3,5-dichloro-2-pyridyloxy)phenoxy]propionic acid(Chlorazifop),
(R)-2-[4-(5-chloro-3-fluoro-2-pyridyloxy)phenoxy]propionic acid(Clodinafop),
(RS)-2-[4-(4-chlorophenoxy)phenoxy]propionic acid(Clofop),
(R)-2-[4-(4-cyano-2-fluorophenoxy)phenoxy]propionic acid(Cyhalofop),
(RS)-2-[4-(2,4-dichlorophenoxy)phenoxy]propionic acid(Diclofop),
(RS)-2-[4-(6-chloro-1,3-benzoxazol-2-yloxy)phenoxy]propionic acid(Fenoxaprop),
(R)-2-[4-(6-chloro-1,3-benzoxazol-2-yloxy)phenoxy]propionic acid(Fenoxaprop P),
(RS)-2-[4-(5-trifluoromethyl-2-pyridyloxy)phenoxy]propionic acid(fluazifop),
(R)-2-[4-(5-trifluoromethyl-2-pyridyloxy)phenoxy]propionic acid(fluazifop-P),
(RS)-2-[4-(3-chloro-5-trifluoromethyl-2-pyridyloxy)phenoxy]propionic acid(haloxyfop),
(RS)-2-{4-[3-chloro-5-(trifluoromethyl)-2-pyridyloxy]phenoxy}propionic acid (haloxyfop),
(RS)-2-[4-(6-chloroquinoxalin-2-yloxy)phenoxy]propionic acid(quizalofop),
(R)-2-[4-(6-chloroquinoxalin-2-yloxy)phenoxy]propionic acid(quizalofop-P),
(RS)-2-[4-(α,α,α-trifluoro-p-tolyloxy)phenoxy]propionic acid(trifop),
3-amino-2,5-dichlorobenzoic acid(Chloramben),
3,6-dichloro-o-anisic acid(Dicamba),
3,5,6-trichloro-o-anisic acid(Tricamba),
(E)-(RS)-3-[1-(allyloxyimino)butyl]4-hydroxy-6,6-dimethyl-2-oxocyclohex-3-enecarboxylic acid (Alloxydim),
(RS)-2-(5-ethyl-2-{[1,2,3,6-tetrahydro-3-methyl-2,6-dioxo-4-(trifluoromethyl)pyrimidin-1-yl]phenoxymethyl}phenoxy)propionic acid (benzfendizone),
(Z)-2-chloro-3-[2-chloro-5-(cyclohex-1-ene-1,2-dicarboximido)phenyl]acrylic acid (Cinidon),
[2-chloro-5-(cyclohex-1-ene-1,2-dicarboximido)₄-fluororophenoxy]acetic acid (flumiclorac),
2-[4,5-dihydro-4-methyl-4-(1-methylethyl)-5-oxo-1H-imidazol-2-yl]4(or 5)-methylbenzoic acid (imazamethabenz),
(RS)-2-(4-isopropyl-4-methyl-5-oxo-2-imidazolin-2-yl)-5-methoxymethylnicotinic acid (imazamox),
(RS)-2-(4-isopropyl-4-methyl-5-oxo-2-imidazolin-2-yl)-5-methylnicotinic acid (imazapic),
2-(4-isopropyl-4-methyl-5-oxo-2-imidazolin-2-yl)nicotinic acid (Imazapyr),
(RS)-2-(4-isopropyl-4-methyl-5-oxo-2-imidazolin-2-yl)quinoline-3-carboxylic acid (Imazaquin),
(RS)-5-ethyl-2-(4-isopropyl-4-methyl-5-oxo-2-imidazolin-2-yl)nicotinic acid (Imazethapyr),
5-(2-chloro-α,α,α-trifluoro-p-tolyloxy)-2-nitrobenzoic acid (acifluorfen),
5-(2,4-dichlorophenoxy)-2-nitrobenzoic acid (Bifenox),
O-[5-(2-chloro-α,α,α-trifluoro-p-tolyloxy)-2-nitrobenzoyl]glycolic acid (Fluoroglycofen),
O-[5-(2-chloro-α,α,α-trifluoro-p-tolyloxy)-2-nitrobenzoyl]-DL-lactic acid (Lactofen),
(2,4-dichlorophenoxy)acetic acid (2,4-D),
4-chlorophenoxyacetic acid (4-CPA),
(4-chloro-2-methylphenoxy)acetic acid (MCPA),
4-(2,4-dichlorophenoxy)butyric acid (2,4-DB),
4-(4-chloro-o-tolyloxy)butyric acid (MCPB),
(RS)-2-(3-chlorophenoxy)propionic acid (cloprop),
(RS)-2-(2,4-dichlorophenoxy)propionic acid (dichlorprop),
(R)-2-(2,4-dichlorophenoxy)propionic acid (dichlorprop-P),
(RS)-2-(4-chloro-o-tolyloxy)propionic acid (mecoprop),
(R)-2-(4-chloro-o-tolyloxy)propionic acid (mecoprop-P),
4-amino-3,6-dichloropyridine-2-carboxylic acid (aminopyralid),
3,6-dichloropyridine-2-carboxylic acid (clopyralid),
4-amino-3,5-dichloro-6-fluoro-2-pyridyloxyacetic acid (fluroxypyr),
4-amino-3,5,6-trichloropyridine-2-carboxylic acid (picloram),
5-[4-bromo-1-methyl-5-(trifluoromethyl)pyrazol-3-yl]-2-chloro-4-fluorobenzoic acid (fluazolate),
2-chloro-5-(4-chloro-5-difluoromethoxy-1-methylpyrazol-3-yl)-4-fluorophenoxyacetic acid (pyraflufen),
2-chloro-5-[1,6-dihydro-5-methyl-6-oxo-4-(trifluoromethyl)pyridazin-1-yl]-4-fluorophenoxyacetic acid(Flufenpyr),
5-bromo-1,6-dihydro-6-oxo-1-phenylpyridazin-4-yloxamic acid(Oxapyrazon),
(RS)-hexahydro-4-hydroxy-3,6-dioxopyridazin-4-ylacetic acid(Pydanon),
2-difluoromethyl-5-(4,5-dihydro-1,3-thiazol-2-yl)-4 isobutyl-6-trifluoromethylnicotinic acid (Thiazopyr),
3,5,6-trichloro-2-pyridyloxyacetic acid(Triclopyr),
2,6-bis(4,&dimethoxypyrimidin-2-yloxy)benzoic acid (Bispyribac),
2-(4,6-dimethoxypyrimidin-2-yloxy)+(1-methoxyiminoethyl)benzoic acid (Pyriminobac),
2-chloro-6-(4,6-dimethoxypyrimidin-2-ylthio)benzoic acid (Pyrithiobac),
3,7-dichloroquinoline-8-carboxylic acid (Quinclorac),
7-chloro-3-methylquinoline-8-carboxylic acid (Quinmerac),
3-chloro-2-(5-ethoxy-7-fluoro[1,2,4]triazolo[1,5-c]pyrimidin-2-ylsulfonamido)benzoic acid (Cloransulam),
(RS)-2-chloro-3-{2-chloro-5-[4-(difluoromethyl)-4,5-dihydro-3-methyl-5-oxo-1H-1,2,4-triazol-1-yl]4-fluorophenyl}propionic acid (Carfentrazone),
[2-chloro-4-fluoro-5-(5,6,7,8-tetrahydro-3-oxo-1H,3H-[1,3,4]thiadiazolo[3,4-a]pyridazin-1-ylideneamino)phenylthio]acetic acid (fluthiacet),
1-(allyloxycarbonyl)-1-methylethyl 2-chloro-5-[1,2,3,6-tetrahydro-3-methyl-2,6-dioxo-4-(trifluoromethyl)pyrimidin-1-yl]benzoic acid (Butafenacil),
2-chloro-5-(1,2,3,6-tetrahydro-3-methyl-2,6-dioxo-4-trifluoromethylpyrimidin-1-yl)benzoic acid (Flupropasil), and
2-{1-[4-(3,5-difluorophenyl)semicarbazono]ethyl nicotinic acid (diflufenzopyr);
R′ is an alkyl group of a polyol containing two or more carbon atoms, which may be linear or branched, saturated or unsaturated, substituted or unsubstituted; and
n is 1 or greater, the maximum number being determined according to the degree of esterification that the polyol will allow.

3. A compound of the formula: (RCOO)ₙ—R′
wherein RCOO is each independently an acetate of an acid selected from the group consisting of
arylalanines, aryloxyphenoxypropionic acids, benzoic acids, cyclohexene oximes, dicarboximides, imidazolinones, nitrophenyl ethers, phenoxyacetic acids. phenoxybutyric acids, phenoxypropionic acids, picolinic acids, pyrazolphenyls, pyridazinones, pyridines, pyrimidinyloxybenzoics, pyrimidinylthiobenzoic acids, quinolinecarboxylics, sulfonanilides, triazolones, uracils, and urea derivatives;
R′ is an alkyl group of a polyol selected from the group consisting of:
glycols (for example: ethylene glycol, propylene glycol, butylenes glycol, hexylene glycol, dipropyleneglycol, triethyleneglycol, methoxytriglycol, ethoxytriglycol, tripropylene glycol methyl ether),
sorbitol,
sorbitan/sorbitol poly(oxyalkylene) condensates (in molecular weight range of 40 a.u. to 20000 a.u.),
D-mannitol,
D-mannitol poly(oxyalkylene) condensates (in molecular weight range of 40 a.u. to 20000 a.u.),
poly(oxyalkylene)glycols in molecular weight range of 80 a.u. to 20000 a.u.,
mono-capped poly(oxyalkylene)glycols in molecular weight range of 80 a.u. to 20000 a.u. capped with an alkyl or aryl group,
pentaerythritol,
pentaerythritol poly(oxyalkylene) condensates,
polyvinylalcohols,
glucosides,
polyglucosides,
polyvinylalcohol polymers,
glycerol,
glycerol poly(oxyalkylene) condensates,
polysaccharides; polysaccharide poly(oxyalkylene) condensates,
polyglycerides,
polyglyceride poly(oxyalkylene) condensates,
poly(oxyalkylene)amines, and
poly(oxyalkylene)etheramines;
n is 1 or greater, the maximum number being determined according to the degree of esterification that the polyol will allow.

4. The compound of claim 2 wherein R′ is an alkyl group of a polyol selected from the group consisting of:
glycols (for example: ethylene glycol, propylene glycol, butylenes glycol, hexylene glycol, dipropyleneglycol, triethyleneglycol, methoxytriglycol, ethoxytriglycol, tripropylene glycol methyl ether),
sorbitol,
sorbitan/sorbitol poly(oxyalkylene) condensates (in molecular weight range of 40 a.u. to 20000 a.u.),
D-mannitol,
D-mannitol poly(oxyalkylene) condensates (in molecular weight range of 40 a.u. to 20000 a.u.),
poly(oxyalkylene)glycols in molecular weight range of 80 a.u. to 20000 a.u.,
mono-capped poly(oxyalkylene)glycols in molecular weight range of 80 a.u. to 20000 a.u. capped with an alkyl or aryl group,
pentaerythritol,
pentaerythritol poly(oxyalkylene) condensates,
polyvinylalcohols,
glucosides,
polyglucosides,
polyvinylalcohol polymers,
glycerol,
glycerol poly(oxyalkylene) condensates,
polysaccharides; polysaccharide poly(oxyalkylene) condensates,
polyglycerides,
polyglyceride poly(oxyalkylene) condensates,
poly(oxyalkylene)amines, and
poly(oxyalkylene)etheramines.

5. A compound of the formula: 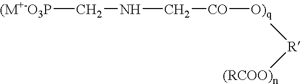
wherein M⁺ is an agronomically acceptable cation;
wherein R—CO—O each independently represents an acetate of an acid selected from the group consisting of:
N-benzoyl-N-(3,4-dichlorophenyl)-DL-alanine (benzoylprop),
N-benzoyl-N-(3-chloro-4-fluorophenyl)-D-alanine (flamprop),
(RS)-2-[4-(3,5-dichloro-2-pyridyloxy)phenoxy]propionic acid (chlorazifop),
(R)-2-[4-(5-chloro-3-fluoro-2-pyridyloxy)phenoxy]propionic acid (clodinafop),
(RS)-2-[4-(4-chlorophenoxy)phenoxy]propionic acid (clofop),
(R)-2-[4-(4-cyano-2-fluorophenoxy)phenoxy]propionic acid (cyhalofop),
(RS)-2-[4-(2,4-dichlorophenoxy)phenoxy]propionic acid (diclofop),
(RS)-2-[4-(6-chloro-1,3-benzoxazol-2-yloxy)phenoxy]propionic acid (fenoxaprop),
(R)-2-[4-(6-chloro-1,3-benzoxazol-2-yloxy)phenoxy]propionic acid (fenoxaprop P),
(RS)-2-[4-(5-trifluoromethyl-2-pyridyloxy)phenoxy]propionic acid (fluazifop),
(R)-2-[4-(5-trifluoromethyl-2-pyridyloxy)phenoxy]propionic acid (fluazifop-P),
(RS)-2-{4-[3-chloro-5-(trifluoromethyl)-2-pyridyloxy]phenoxy}propionic acid (haloxyfop),
(RS)-2-[4-(6-chloroquinoxalin-2-yloxy)phenoxy]propionic acid (quizalofop),
(R)-2-[4-(6-chloroquinoxalin-2-yloxy)phenoxy]propionic acid (quizalofop-P),
(RS)-2-[4-(α,α,α-trifluoro-p-tolyloxy)phenoxy]propionic acid (trifop),
3-amino-2,5-dichlorobenzoic acid (chloramben),
3,6-dichloroanisic acid (dicamba),
3,5,6-trichloro-o-anisic acid (tricamba),
(E)-(RS)-3-[1-(allyloxyimino)butyl]-4-hydroxy-6,6-dimethyl-2-oxocyclohex-3-enecarboxylic acid (alloxydim),
(RS)-2-(5-ethyl-2-{4-[1,2,3,6-tetrahydro-3-methyl-2,6-dioxo-4-(trifluoromethyl)pyrimidin-1-yl]phenoxymethyl}phenoxy)propionic acid (benzfendizone),
(Z)-2-chloro-3-[2-chloro-5-(cyclohex-1-ene-1,2-dicarboximido)phenyl]acrylic acid (cinidon),
[2-chloro-5-(cyclohex-1-ene-1,2-dicarboximido)-4-fluororophenoxy]acetic acid (flumiclorac),
2-[4,5-dihydro-4-methyl-4-(1-methylethyl)-5-oxo-1H-imidazol-2-yl]4(or 5)-methylbenzoic acid (imazamethabenz),
(RS)-2-(4-isopropyl-4-methyl-5-oxo-2-imidazolin-2-yl)-5-methoxymethylnicotinic acid (imazamox),
(RS)-2-(4-isopropyl-4-methyl-5-oxo-2-imidazolin-2-yl)-5-methylnicotinic acid (imazapic),
2-(4 isopropylmethyl-5-oxo-2-imidazolin-2-yl)nicotinic acid (imazapyr),
(RS)-2-(4-isopropyl-4-methyl-5-oxo-2-imidazolin-2-yl)quinoline-3-carboxylic acid (imazaquin),
(RS)-5-ethyl-2-(4-isopropyl-4-methyl-5-oxo-2-imidazolin-2-yl)nicotinic acid (imazethapyr),
5-(2-chloro-α,α,α-trifluoro-p-tolyloxy)-2-nitrobenzoic acid (acifluorfen),
5-(2,4-dichlorophenoxy)-2-nitrobenzoic acid (bifenox),
O-[5-(2-chloro-α,α,α-trifluoro-p-tolyloxy)-2-nitrobenzoyl]glycolic acid (fluoroglycofen),
O-[5-(2-chloro-α,α,α-trifluoro-p-tolyloxy)-2-nitrobenzoyl]-DL-lactic acid (lactofen),
2,4-dichlorophenoxy)acetic acid (2,4-D),
4-chlorophenoxyacetic acid (4-CPA),
(4-chloro-2-methylphenoxy)acetic acid (mcpa),
4-(2,4-dichlorophenoxy)butyric acid (2,4-DB),
4-(4-chloro-o-tolyloxy)butyric acid (mcpb),
(RS)-2-(3-chlorophenoxy)propionic acid (cloprop),
(RS)-2-(2,4-dichlorophenoxy)propionic acid (dichlorprop),
(R)-2-(2,4-dichlorophenoxy)propionic acid (dichlorprop-P),
RS)-2-(4-chloro-o-tolyloxy)propionic acid (mecoprop),
(R)-2-(4-chlorotolyloxy)propionic acid (mecoprop-P),
4-amino-3,6-dichloropyridine-2-carboxylic acid (aminopyralid),
3,6-dichloropyridine-2-carboxylic acid (clopyralid),
4-amino-3,5-dichloro-6-fluoro-2-pyridyloxyacetic acid (fluroxypyr),
4-amino-3,5,6-trichloropyridine-2-carboxylic acid (picloram),
5-[4-bromo-1-methyl-5-(trifluoromethyl)pyrazol-3-yl]-2-chloro-4-fluorobenzoic acid (fluazolate),
2-chloro-5-(4-chloro-5-difluoromethoxy-1-methylpyrazol-3-yl)-4-fluorophenoxyacetic acid (pyraflufen),
2-chloro-5-[1,6-dihydro-5-methyl-6-oxo(trifluoromethyl)pyridazin-1-yl]4 fluorophenoxyacetic acid (flufenpyr),
5-bromo-1,6-dihydro-6-oxo-1-phenylpyridazin-4-yloxamic acid (oxapyrazon),
(RS)-hexahydro-4-hydroxy-3,6-dioxopyridazin-4-ylacetic acid (pydanon),
2-difluoromethyl-5-(4,5-dihydro-1,3-thiazol-2-yl)-4-isobutyl-6-trifluoromethylnicotinic acid (thiazopyr),
3,5,6-trichloro-2-pyridyloxyacetic acid (Triclopyr),
2,6-bis(4,6-dimethoxypyrimidin-2-yloxy)benzoic acid (Bispyribac),
2-(4,6-dimethoxypyrimidin-2-yloxy)-6-(1-methoxyiminoethyl)benzoic acid (Pyriminobac),
2-chloro-6-(4,6-dimethoxypyrimidin-2-ylthio)benzoic acid (pyrithiobac),
3,7-dichloroquinoline-8-carboxylic acid (Quinclorac),
7-chloro-3-methylquinoline-8-carboxylic acid (Quinmerac),
(RS)-2-chloro-3-(2-chloro-5-[4-(difluoromethyl)-4,5-dihydro-3-methyl-5-oxo-1H-1,2,4-triazol-1-yl]4-fluorophenyl}propionic acid (Carfentrazone),
[2-chloro-4-fluoro-5-(5,6,7,8-tetrahydro-3-oxo-1H,3H-[1,3,4]thiadiazolo[3,4-a]pyridazin-1-ylideneamino)phenylthio]acetic acid (Fluthiacet),
1-(allyloxycarbonyl)-1-methylethyl 2-chloro-5-[1,2,3,6-tetrahydro-3-methyl-2,6-dioxo-4-(trifluoromethyl)pyrimidin-1-yl]benzoic acid (Butafenacil),
2-chloro-5-(1,2,3,6-tetrahydro-3-methyl-2,6-dioxo-4-trifluoromethylpyrimidin-1-yl)benzoic acid (flupropasil), and
2-{1-[4-(3,5-difluorophenyl)semicarbazono]ethyl}nicotinic acid (diflufenzopyr);
R′ is an alkyl group of a polyol containing two or more carbon atoms, which may be linear or branched, saturated or unsaturated, and substituted or unsubstituted; and
n is 1 or greater, the maximum number being determined according to the degree of esterification that the polyol will allow; and
q is 1 or greater, the maximum number being determined according to the degree of esterification that the polyol will allow.

6. The compound of claim 5 wherein the alkyl group of the polyol contains a nitrogen or oxygen heteroatom.

7. The compound of claim 5 wherein R′ is the alkyl group of a polyol selected from the group consisting of:
glycols,
sorbitol,
sorbitan/sorbitol poly(oxyalkylene) condensates (in molecular weight range of 40 a.u. to 20000 a.u.),
D-mannitol,
D-mannitol poly(oxyalkylene) condensates (in molecular weight range of 40 a.u. to 20000 a.u.),
poly(oxyalkylene)glycols in molecular weight range of 80 a.u. to 20000 a.u.,
poly(oxyethylene)poly(oxypropylene)glycol in molecular weight range of 80 a.u. to 20000 a.u.,
glucosides;
pentaerythritol,
pentaerythritol poly(oxyalkylene) condensates,
polyvinylalcohols,
polyglucosides,
polyvinylalcohol polymers,
glycerol,
glycerol poly(oxyalkylene) condensates,
polysaccharides,
polysaccharide poly(oxyalkylene) condensates,
polyglycerides,
polyglyceride poly(oxyalkylene) condensates,
poly(oxyalkylene)amines, and
poly(oxyalkylene)etheramines.

8. A compound of the formula: 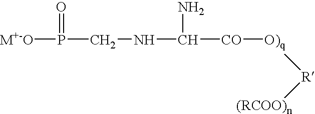
wherein M⁺ is an agronomically acceptable cation;
wherein R—CO—O each independently represents an acetate of a carboxylic acid that presents herbicidal properties;
R′ is an alkyl group of a polyol containing two or more carbon atoms, which may be linear or branched, saturated or unsaturated, and substituted or unsubstituted; and
n is 1 or greater, the maximum number being determined according to the degree of esterification that the polyol will allow; and
q is 1 or greater, the maximum number being determined according to the degree of esterification that the polyol will allow.

9. The compound of claim 8 wherein the alkyl group contains a nitrogen or oxygen heteroatom.

10. A compound of the formula: 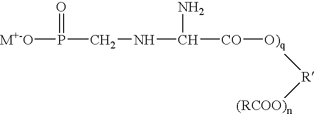
wherein M⁺ is an agronomically acceptable cation;
wherein R—CO—O each independently represents an acetate of an acid selected from the group consisting of:
N-benzoyl-N-(3,4-dichlorophenyl)-DL-alanine (benzoylprop),
N-benzoyl-N-(3-chloro-4-fluorophenyl)-D-alanine (flamprop),
(RS)-2-[4-(3,5-dichloro-2-pyridyloxy)phenoxy]propionic acid (chlorazifop),
(R)-2-[4-(5-chloro-3-fluoro-2-pyridyloxy)phenoxy]propionic acid (clodinafop),
(RS)-2-[4-(4-chlorophenoxy)phenoxy]propionic acid (clofop),
(R)-2-[4-(4-cyano-2-fluorophenoxy)phenoxy]propionic acid (cyhalofop),
(RS)-2-[4-(2,4-dichlorophenoxy)phenoxy]propionic acid (diclofop),
(RS)-2-[4-(6-chloro-1,3-benzoxazol-2-yloxy)phenoxy]propionic acid (fenoxaprop),
(R)-2-[4-(6-chloro-1,3-benzoxazol-2-yloxy)phenoxy]propionic acid (fenoxaprop-P),
(RS)-2-[4-(5-trifluoromethyl-2-pyridyloxy)phenoxy]propionic acid (fluazifop),
(R)-2-[4-(5-trifluoromethyl-2-pyridyloxy)phenoxy]propionic acid (fluazifop-P),
(RS)-2-{4-[3-chloro-5-(trifluoromethyl)-2-pyridyloxy]phenoxy}propionic acid (haloxyfop),
(RS)-2-[4-(6-chloroquinoxalin-2-yloxy)phenoxy]propionic acid (quizalofop),
(R)-2-[4-(6-chloroquinoxalin-2-yloxy)phenoxy]propionic acid (quizalofop-P),
(RS)-2-[4-(α,α,α-trifluoro-p-tolyloxy)phenoxy]propionic acid (trifop),
3-amino-2,5-dichlorobenzoic acid (chloramben),
3,6-dichloro-o-anisic acid (dicamba),
3,5,6-trichloroanisic acid (tricamba),
(E)-(RS)-3-[1-(allyloxyimino)butyl]4-hydroxy-6,6-dimethyl-2-oxocyclohex-3-enecarboxylic acid (alloxydim),
(RS)-2-(5-ethyl-2-{4-[1,2,3,6-tetrahydro-3-methyl-2,6-dioxo-4-(trifluoromethyl)pyrimidin-1-yl]phenoxymethyl}phenoxy)propionic acid (benzfendizone),
(Z)-2-chloro-3-[2-chloro-5-(cyclohex-1-ene-1,2-dicarboximido)phenyl]acrylic acid (cinidon),
[2-chloro-5-(cyclohex-1-ene-1,2-dicarboximido)-4-fluororophenoxy]acetic acid (flumiclorac),
2-[4,5-dihydro-4-methyl-4-(1-methylethyl)-5-oxo-1H-imidazol-2-yl]4(or 5)-methylbenzoic acid (imazamethabenz),
(RS)-2-(4-isopropyl-4-methyl-5-oxo-2-imidazolin-2-yl)-5-methoxymethylnicotinic acid (imazamox),
(RS)-2-(4-isopropyl-4-methyl-5-oxo-2-imidazolin-2-yl)-5-methylnicotinic acid (imazapic),
2-(4-isopropyl-4-methyl-5-oxo-2-imidazolin-2-yl)nicotinic acid (imazapyr),
(RS)-2-(4-isopropyl-4-methyl-5-oxo-2-imidazolin-2-yl)quinoline-3-carboxylic acid (imazaquin),
(RS)-5-ethyl-2-(4-isopropyl-4-methyl-5-oxo-2-imidazolin-2-yl)nicotinic acid (imazethapyr),
5-(2-chloro-α,α,α-trifluoro-p-tolyloxy)-2-nitrobenzoic acid (acifluorfen),
5-(2,4-dichlorophenoxy)-2-nitrobenzoic acid (bifenox),
O-[5-(2-chloro-α,α,α-trifluoro-p-tolyloxy)-2-nitrobenzoyl]glycolic acid (fluoroglycofen),
O-[5-(2-chloro-α,α,α-trifluoro-p-tolyloxy)-2-nitrobenzoyl]-DL-lactic acid (lactofen),
2,4-dichlorophenoxy)acetic acid (2,4-D),
4-chlorophenoxyacetic acid (4-CPA),
(4-chloro-2-methylphenoxy)acetic acid (mcpa),
4-(2,4-dichlorophenoxy)butyric acid (2,4-DB),
4-(4-chloro-o-tolyloxy)butyric acid (mcpb),
(RS)-2-(3-chlorophenoxy)propionic acid (cloprop),
(RS)-2-(2,4-chlorophenoxy)propionic acid (dichlorprop),
(R)-2-(2,4-dichlorophenoxy)propionic acid (dichlorprop-P),
RS)-2-(4-chloro-o-tolyloxy)propionic acid (mecoprop),
(R)-2-(4-chloro)tolyloxy)propionic acid (mecoprop-P),
4-amino-3,6-dichloropyridine-2-carboxylic acid (aminopyralid),
3,6-dichloropyridine-2-carboxylic acid (clopyralid),
4-amino-3,5-dichloro-6-fluoro-2-pyridyloxyacetic acid (fluroxypyr),
4-amino-3,5,6-trichloropyridine-2-carboxylic acid (picloram),
5-[4-bromo-1-methyl-5-(trifluoromethyl)pyrazol-3-yl]-2-chloro-4-fluorobenzoic acid (fluazolate),
2-chloro-5-(4-chloro-5-difluoromethoxy-1-methylpyrazol-3-yl)₄-fluorophenoxyacetic acid (pyraflufen),
2-chloro-5-[1,6-dihydro-5-methyl-6-oxo-(trifluoromethyl)pyridazin-1-yl]-4-fluorophenoxyacetic acid (flufenpyr),
5-bromo-1,6-dihydro-6-oxo-1-phenylpyridazin-4-yloxamic acid (oxapyrazon),
(RS)-hexahydrohydroxy-3,6-dioxopyridazin-4-ylacetic acid (pydanon),
2-difluoromethyl-5-(4,5-dihydro-1,3-thiazol-2-yl)₄-isobutyl-6-trifluoromethylnicotinic acid (thiazopyr),
3,5,6-trichloro-2-pyridyloxyacetic acid (Triclopyr),
2,6-bis(4,6-dimethoxypyrimidin-2-yloxy)benzoic acid (Bispyribac),
2-(4,6-dimethoxypyrimidin-2-yloxy)-6-(1-methoxyiminoethyl)benzoic acid (Pyriminobac),
2-chloro-6-(4,6-dimethoxypyrimidin-2-ylthio)benzoic acid (pyrithiobac),
3,7-dichloroquinoline-8-carboxylic acid (Quinclorac),
7-chloro-3-methylquinoline-8-carboxylic acid (Quinmerac),
(RS)-2-chloro-3-{2-chloro-5-[4-(difluoromethyl)-4,5-dihydro-3-methyl-5-oxo-1H-1,2,4-triazol-1-yl]4-fluorophenyl}propionic acid (Carfentrazone),
[2-chloro-4-fluoro-5-(5,6,7,8-tetrahydro-3-oxo-1H,3H-[1,3,4]thiadiazolo[3,4-a]pyridazin-1-ylideneamino)phenylthio]acetic acid (Fluthiacet),
1-(allyloxycarbonyl)-1-methylethyl 2-chloro-5-[1,2,3,6-tetrahydro-3-methyl-2,6-dioxo-4-(trifluoromethyl)pyrimidin-1-yl]benzoic acid (Butafenacil),
2-chloro-5-(1,2,3,6-tetrahydro-3-methyl-2,6-dioxo-4-trifluoromethylpyrimidin-1-yl)benzoic acid (flupropasil), and
2-{1-[(3,5-difluorophenyl)semicarbazono]ethyl}nicotinic acid (diflufenzopyr);
R′ is an alkyl group of a polyol containing two or more carbon atoms, which may be linear or branched, saturated or unsaturated, and substituted or unsubstituted; and
n is 1 or greater, the maximum number being determined according to the degree of esterification that the polyol will allow; and
q is 1 or greater, the maximum number being determined according to the degree of esterification that the polyol will allow.

11. The compound of claim 10 wherein the alkyl group of the polyol contains a nitrogen or oxygen heteroatom.

12. The compound of claim 10 wherein R′ is the alkyl group of a polyol selected from the group consisting of:
glycols,
sorbitol,
sorbitan/sorbitol poly(oxyalkylene) condensates (in molecular weight range of 40 a.u. to 20000 a.u.),
D-mannitol,
D-mannitol poly(oxyalkylene) condensates (in molecular weight range of 40 a.u. to 20000 a.u.),
poly(oxyalkylene)glycols in molecular weight range of 80 a.u. to 20000 a.u.,
poly(oxyethylene)poly(oxypropylene)glycol in molecular weight range of 80 a.u. to 20000 a.u.,
glucosides;
pentaerythritol,
pentaerythritol poly(oxyalkylene) condensates,
polyvinylalcohols,
polyglucosides,
polyvinylalcohol polymers,
glycerol,
glycerol poly(oxyalkylene) condensates,
polysaccharides,
polysaccharide poly(oxyalkylene) condensates,
polyglycerides,
polyglyceride poly(oxyalkylene) condensates,
poly(oxyalkylene)amines, and
poly(oxyalkylene)etheramines.

13. A compound of the formula
(R¹—CO—O)ₙ—R³—(O—OC—R²)ₘ
wherein R¹—CO—O each independently represents an acetate of an acid selected from the group consisting of:
3-chloro-5-(4,6-dimethoxypyrimidin-2-ylcarbamoylsulfamoyl)-1-methylpyrazole-4-carboxylic acid (Halosulfuron),
3-[(4,6-dimethoxypyrimidin-2-ylcarbamoyl)sulfamoyl]-6-(trifluoromethyl)nicotinic acid (Flupyrsulfuron),
2-[[[[(4,6-dimethoxy-2-pyrimidinyl)amino]carbonyl]amino]sulfonyl]4-[[(methylsulfonyl)amino]methyl]benzoic acid (Mesosulfuron),
2-[4,6-bis(difluoromethoxy)pyrimidin-2-ylcarbamoylsulfamoyl]benzoic acid (Primisulfuron),
5-[(4,6-dimethoxypyrimidin-2-ylcarbamoyl)sulfamoyl]-1-methylpyrazole-4-carboxylic acid (Pyrazosulfuron),
3-chloro-5-(4,6-dimethoxypyrimidin-2-ylcarbamoylsulfamoyl)-1-methylpyrazole-4-carboxylate,
5-(4,6-dimethylpyrimidin-2-yl-carbamoylsulfamoyl)-1-(2-pyrid-yl)pyrazole-4-carboxylic acid,
3-chloro-2-(5-ethoxy-7-fluoro[1,2,4]triazolo[1,5-c]pyrimidin-2-ylsulfonamido)benzoic acid (Cloransulam),
2-[(4-ethoxy-6-methylamino-1,3,5-triazin-2-yl)carbamoylsulfamoyl]benzoic acid (Ethametsulfuron),
4-iodo-2-[3-(4-methoxy-6-methyl-1,3,5-triazin-2-yl)ureidosulfonyl]benzoic acid (Iodosulfuron),
3-(4-methoxy-6-methyl-1,3,5-triazin-2-ylcarbamoylsulfamoyl)thiophene-2-carboxylic acid (Thifensulfuron),
2-[4-methoxy-6-methyl-1,3,5-triazin-2-yl(methyl)carbamoylsulfamoyl]benzoic acid (Tribenuron),
2-[4-dimethylamino-6-(2,2,2-trifluoroethoxy)-1,3,5-triazin-2-ylcarbamoylsulfamoyl]-m-toluic acid (Triflusulfuron), and
3-(4-ethyl-6-methoxy-1,3,5-triazin-2-yl)-1-(2,3-dihydro-1,1-dioxo-2-methylbenzo[b]thiophen-7-sulfonyl)urea;
wherein R²—CO—O each independently represents an acetate of an acid selected from the group consisting of:
N-benzoyl-N-(3,4-dichlorophenyl)-DL-alanine (benzoylprop),
N-benzoyl-N-(3-chloro-4-fluorophenyl)-D-alanine (flamprop),
(RS)-2-[4-(3,5-dichloro-2-pyridyloxy)phenoxy]propionic acid (chlorazifop),
(R)-2-[4-(5-chloro-3-fluoro-2-pyridyloxy)phenoxy]propionic acid (clodinafop),
(RS)-2-[4-(4-chlorophenoxy)phenoxy]propionic acid (clofop),
(R)-2-[4-(4-cyano-2-fluorophenoxy)phenoxy]propionic acid (cyhalofop),
(RS)-2-[4-(2,4-dichlorophenoxy)phenoxy]propionic acid (diclofop),
(RS)-2-[4-(6-chloro-1,3-benzoxazol-2-yloxy)phenoxy]propionic acid (fenoxaprop),
(R)-2-[4-(6-chloro-1,3-benzoxazol-2-yloxy)phenoxy]propionic acid (fenoxaprop-P),
(RS)-2-[4-(5-trifluoromethyl-2-pyridyloxy)phenoxy]propionic acid (fluazifop),
(R)-2-[4-(5-trifluoromethyl-2-pyridyloxy)phenoxy]propionic acid (fluazifop-P),
(RS)-2-{4-[3-chloro-5-(fluoromethyl)-2-pyridyloxy]phenoxy}propionic acid (haloxyfop),
(RS)-2-[4-(6-chloroquinoxalin-2-yloxy)phenoxy]propionic acid (quizalofop),
(R)-2-[4-(6-chloroquinoxalin-2-yloxy)phenoxy]propionic acid (quizalofop-P),
(RS)-2-[4-(α,α,α-trifluoro-p-tolyloxy)phenoxy]propionic acid (trifop),
3-amino-2,5-dichlorobenzoic acid (chloramben),
3,6-dichloroanisic acid (dicamba),
3,5,6-trichloro-o-anisic acid (tricamba),
(E)-(RS)-3-[1-(allyloxyimino)butyl]+hydroxy-6,6-dimethyl-2-oxocyclohex-3-enecarboxylic acid (alloxydim),
(RS)-2-(5-ethyl-2-{4-[1,2,3,6-tetrahydro-3-methyl-2,6-dioxo-4-(trifluoromethyl)pyrimidin-1-yl]phenoxymethyl}phenoxy)propionic acid (benzfendizone),
(Z)-2-chloro-3-[2-chloro-5-(cyclohex-1-ene-1,2-dicarboximido)phenyl]acrylic acid (cinidon),
[2-chloro-5-(cyclohex-1-ene-1,2-dicarboximido)₄-fluororophenoxy]acetic acid (flumiclorac),
2-[4,5-dihydro-4-methyl-4-(1-methylethyl)-5-oxo-1H-imidazol-2-yl]4(or 5)-methylbenzoic acid (imazamethabenz),
(RS)-2-(4 isopropyl-4-methyl-5-oxo-2-imidazolin-2-yl)-5-methoxymethylnicotinic acid (imazamox),
(RS)-2-(4-isopropyl-4-methyl-5-oxo-2-imidazolin-2-yl)-5-methylnicotinic acid (imazapic),
2-(4-isopropyl-4-methyl-5-oxo-2-imidazolin-2-yl)nicotinic acid (imazapyr),
(RS)-2-(4-isopropyl-4-methyl-5-oxo-2-imidazolin-2-yl)quinoline-3-arboxylic acid (imazaquin),
(RS)-5-ethyl-2-(4-isopropyl-4-methyl-5-oxo-2-imidazolin-2-yl)nicotinic acid (imazethapyr),
5-(2-chloro-α,α,α-trifluoro-p-tolyloxy)-2-nitrobenzoic acid (acifluorfen),
5-(2,4-dichlorophenoxy)-2-nitrobenzoic acid (bifenox),
O-[5-(2-chloro-α,α,α-trifluoro-tolyloxy)-2-nitrobenzoyl]glycolic acid (fluoroglycofen),
O-[5-(2-chloro-α,α,α-trifluoro-p-tolyloxy)-2-nitrobenzoyl]-DL-lactic acid (lactofen),
2,4-dichlorophenoxy)acetic acid (2,4-D),
4-chlorophenoxyacetic acid (4-CPA),
(4-chloro-2-methylphenoxy)acetic acid (mcpa),
4-(2,4-dichlorophenoxy)butyric acid (2,4-DB),
4-(4-chlorotolyloxy)butyric acid (mcpb),
(RS)-2-(3-chlorophenoxy)propionic acid (cloprop),
(RS)-2-(2,4-dichlorophenoxy)propionic acid (dichlorprop),
(R)-2-(2,4-dichlorophenoxy)propionic acid (dichlorprop-P),
RS)-2-(4-chloro-o-tolyloxy)propionic acid (mecoprop),
(R)-2-(4-chloro-o-tolyloxy)propionic acid (mecoprop-P),
4-amino-3,6-dichloropyridine-2-carboxylic acid (aminopyralid),
3,6-dichloropyridine-2-carboxylic acid (clopyralid),
4-amino-3,5-dichloro-6-fluoro-2-pyridyloxyacetic acid (fluroxypyr),
4-amino-3,5,6-trichloropyridine-2-carboxylic acid (picloram),
5-[4-bromo-1-methyl-5-(trifluoromethyl)pyrazol-3-yl]-2-chloro-4-fluorobenzoic acid (fluazolate),
2-chloro-5-(4-chloro-5-difluoromethoxy-1-methylpyrazol-3-yl)₄-fluorophenoxyacetic acid (pyraflufen),
2-chloro-5-[1,6-dihydro-5-methyl-6-oxo-4-(trifluoromethyl)pyridazin-1-yl]4-fluorophenoxyacetic acid (flufenpyr),
5-bromo-1,6-dihydro-6-oxo-1-phenylpyridazin-4-yloxamic acid (oxapyrazon),
(RS)-hexahydro-4-hydroxy-3,6-dioxopyridazin-4-ylacetic acid (pydanon),
2-difluoromethyl-5-(4,5-dihydro-1,3-thiazol-2-yl)-4-isobutyl-6-trifluoromethylnicotinic acid (thiazopyr),
3,5,6-trichloro-2-pyridyloxyacetic acid (Triclopyr),
2,6-bis(4,&dimethoxypyrimidin-2-yloxy)benzoic acid (Bispyribac),
2-(4,6-dimethoxypyrimidin-2-yloxy)-6-(1-methoxyiminoethyl)benzoic acid (Pyriminobac),
2-chloro-6-(4,6-dimethoxypyrimidin-2-ylthio)benzoic acid (pyrithiobac),
3,7-dichloroquinoline-8-arboxylic acid (Quinclorac),
7-chloro-3-methylquinoline-8-carboxylic acid (Quinmerac),
(RS)-2-chloro-3-{2-chloro-5-[4-(difluoromethyl)-4,5-dihydro-3-methyl-5-oxo-1H-1,2,4-triazol-1-yl]4-fluorophenyl}propionic acid (Carfentrazone),
[2-chloro-4-fluor-5-(5,6,7,8-tetrahydro-3-oxo-1H,3H-[1,3,4]thiadiazolo[3,4-a]pyridazin-1-ylideneamino)phenylthio]acetic acid (Fluthiacet),
1-(allyloxycarbonyl)-1-methylethyl 2-chloro-5-[1,2,3,6-tetrahydro-3-methyl-2,6-dioxo-4-(trifluoromethyl)pyrimidin-1-yl]benzoic acid (Butafenacil),
2-chloro-5-(1,2,3,6-tetrahydro-3-methyl-2,6-dioxo-4-trifluoromethylpyrimidin 1-yl)benzoic acid (flupropasil), and
2-{1-[4-(3,5-fluorophenyl)semicarbazono]ethyl}nicotinic acid (diflufenzopyr);
R³ is an alkyl group of a polyol selected from the group consisting of:
glycols (for example: ethylene glycol, propylene glycol, butylenes glycol, hexylene glycol, dipropyleneglycol, triethyleneglycol, methoxytriglycol, ethoxytriglycol, tripropylene glycol methyl ether),
sorbitol,
sorbitan/sorbitol poly(oxyalkylene) condensates (in molecular weight range of 40 a.u. to 20000 a.u.),
D-mannitol,
D-mannitol poly(oxyalkylene) condensates (in molecular weight range of 40 a.u. to 20000 a.u.),
poly(oxyalkylene)glycols in molecular weight range of 80 a.u. to 20000 a.u.,
poly(oxyethylene)poly(oxypropylene)glycol in molecular weight range of 80 a.u. to 20000 a.u.,
pentaerythritol,
pentaerythritol poly(oxyalkylene) condensates,
polyvinylalcohols,
glucosides,
polyglucosides,
polyvinylalcohol polymers,
glycerol,
glycerol poly(oxyalkylene) condensates,
polysaccharides; polysaccharide poly(oxyalkylene) condensates,
polyglycerides,
polyglyceride poly(oxyalkylene) condensates,
poly(oxyalkylene)amines, and
poly(oxyalkylene)etheramines;
n is 1 or greater; and m is 0 or greater,
with the proviso that when n is 1, m is 1 or greater, the maximum number for m being determined according to the degree of esterification that the polyol will allow (determined by the number of hydoxyl groups present); and when n is greater than 1, m is 0 or greater, the maximum number for n or m being determined by the formula that the sum of n+m cannot exceed the maximum number determined according to the degree of esterification that the polyol will allow.

14. A composition suitable for the controlling the growth of unwanted vegetation which comprises a herbicidally effective amount of a compound in claim 4 and a compound selected from the group consisting of surfactant, solid diluent, liquid diluent and mixtures thereof.

15. A composition suitable for the controlling the growth of unwanted vegetation which comprises a herbicidally effective amount of a compound in claim 5 and a compound selected from the group consisting of surfactant, solid diluent, liquid diluent and mixtures thereof.

16. A composition suitable for the controlling the growth of unwanted vegetation which comprises a herbicidally effective amount of a compound in claim 8 and a compound selected from the group consisting of surfactant, solid diluent, liquid diluent and mixtures thereof.

17. A composition suitable for the controlling the growth of unwanted vegetation which comprises a herbicidally effective amount of a compound in claim 13 and a compound selected from the group consisting of surfactant, solid diluent, liquid diluent and mixtures thereof.

18. A method for controlling the development of undesired vegetation which comprises applying to the locus to be protected a herbicidally effective amount of a compound of claim 4.

19. A method for controlling the development of undesired vegetation which comprises applying to the locus to be protected a herbicidally effective amount of a compound of claim 5.

20. A method for controlling the development of undesired vegetation which comprises applying to the locus to be protected a herbicidally effective amount of a compound of claim 8.

21. A method for controlling the development of undesired vegetation which comprises applying to the locus to be protected a herbicidally effective amount of a compound of claim 13.
